(19) United States
(12) Patent Application Publication
(10) Pub. No.: US 2026/0302440 A1
(43) Pub. Date: Oct. 1, 2026

(54) BATTERY CELL

(71) Applicant: TOYOTA JIDOSHA KABUSHIKI KAISHA, Toyota-shi (JP)

(72) Inventors: Masato ONO, Nagoya-shi (JP); Atsushi SUGIHARA, Toyota-shi (JP); Satoshi NAKASHIMA, Toyota-shi (JP); Masayoshi HAGA, Nagoya-shi (JP); Jun IZUMI, Toyota-shi (JP); Masahiro ISHIZUKA, Toyota-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 19/533,690

(22) Filed: Feb. 9, 2026

(30) Foreign Application Priority Data
Mar. 27, 2025 (JP) 2025-053891

(51) Int. Cl. H01M 50/124; H01M 10/653; H01M 50/105; H01M 50/121; H01M 50/126

(52) U.S. Cl. CPC H01M 50/1245; H01M 10/653; H01M 50/105; H01M 50/121; H01M 50/126

(57) ABSTRACT

The battery cell includes a battery main body, an accommodation member that houses the battery main body, and a resin member. The accommodation member includes a first film section that covers a first surface of the battery main body and a second film section that covers a second surface of the battery main body on a side opposite to the first surface. A welding portion where an inner surface of the first film section and an inner surface of the second film section are welded is provided on a side surface of the accommodation member, the welding portion protruding from the side surface. The resin member covers the side surface of the accommodation member and the welding portion.

### CROSS-REFERENCE TO RELATED APPLICATION

This application claims priority to Japanese Patent Application No. 2025-053891 filed on Mar. 27, 2025. The disclosure of the above-identified application, including the specification, drawings, and claims, is incorporated by reference herein in its entirety.

### BACKGROUND

### 1. Technical Field

The technology disclosed in the present specification relates to a battery cell.

### 2. Description of Related Art

A battery cell of Japanese Unexamined Patent Application Publication No. 2020-004712 (JP 2020-004712 A) includes a battery main body and an accommodation member. The battery main body is accommodated in the accommodation member. The accommodation member includes a first film section that covers one surface of the battery main body and a second film section that covers another surface of the battery main body. A welding portion in which an inner surface of the first film section and an inner surface of the second film section are welded is provided on a side surface of the accommodation member.

### SUMMARY

In a case where a sealing capability of the welding portion is deteriorated, a gas and a liquid are likely to move between an inside and an outside of the accommodation member through the welding portion, and the quality of the battery cell is deteriorated. In the present specification, a technique of achieving a high sealing capability in a welding portion is proposed.

A battery cell according to a first aspect of the present disclosure includes a battery main body, an accommodation member that accommodates the battery main body, and a resin member. The accommodation member includes a first film section that covers a first surface of the battery main body, and a second film section that covers a second surface on a side opposite to the first surface. A welding portion in which an inner surface of the first film section and an inner surface of the second film section are welded is provided on a side surface of the accommodation member, the welding portion protruding from the side surface. The resin member covers the side surface of the accommodation member and the welding portion.

In the battery cell, the resin member covers the side surface of the accommodation member and the welding portion. Therefore, it is possible to achieve a high sealing capability in the welding portion.

In the battery cell according to the first aspect of the present disclosure, the side surface of the accommodation member includes a first side surface and a second side surface extending in a direction intersecting the first side surface when the side surface is viewed in a plan view along a thickness direction of the battery cell; the welding portion includes a first welding portion provided on the first side surface and a second welding portion provided on the second side surface; and the resin member covers the first side surface, the first welding portion, the second side surface, and the second welding portion.

With the battery cell, since the resin member covers the first side surface and the second side surface, it is possible to improve the rigidity of the battery cell.

In the battery cell according to the first aspect of the present disclosure, the length of the battery main body is at least 5 times the width of the battery main body.

The battery cell according to the first aspect of the present disclosure further includes a heat conduction member that covers a surface of the resin member, the heat conduction member having a thermal conductivity higher than a thermal conductivity of the resin member.

With the battery cell, heat generated in the battery main body is likely to be released to an outside.

The battery cell according to the first aspect of the present disclosure further includes a sealing material provided between the resin member and the welding portion.

With the battery cell, it is possible to achieve the higher sealing capability in the welding portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery cell of Embodiment 1;

FIG. 2 is a top view of the battery cell of Embodiment 1;

FIG. 3 is a cross-sectional view of the battery cell before sealing of the accommodation member;

FIG. 4 is a top view of the battery cell after sealing of the accommodation member and before providing the resin member;

FIG. 5 is a cross-sectional view taken along line V-V of FIG. 2;

FIG. 6 is a cross-sectional view of a battery cell of Embodiment 2 (cross-sectional view corresponding to FIG. 5); and

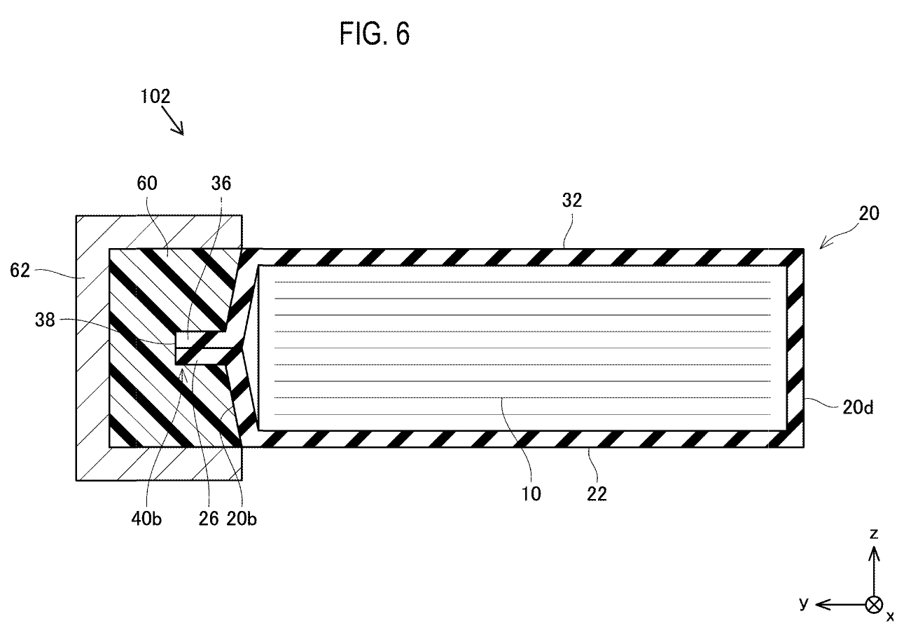

FIG. 7 is a cross-sectional view of a battery cell of Embodiment 3 (cross-sectional view corresponding to FIG. 5).

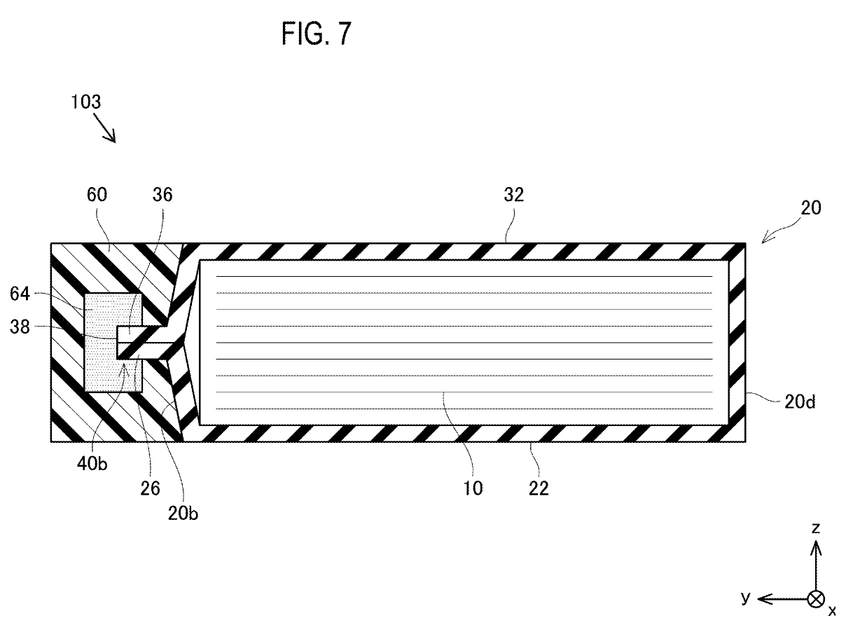

### DETAILED DESCRIPTION OF EMBODIMENTS

### Embodiment 1

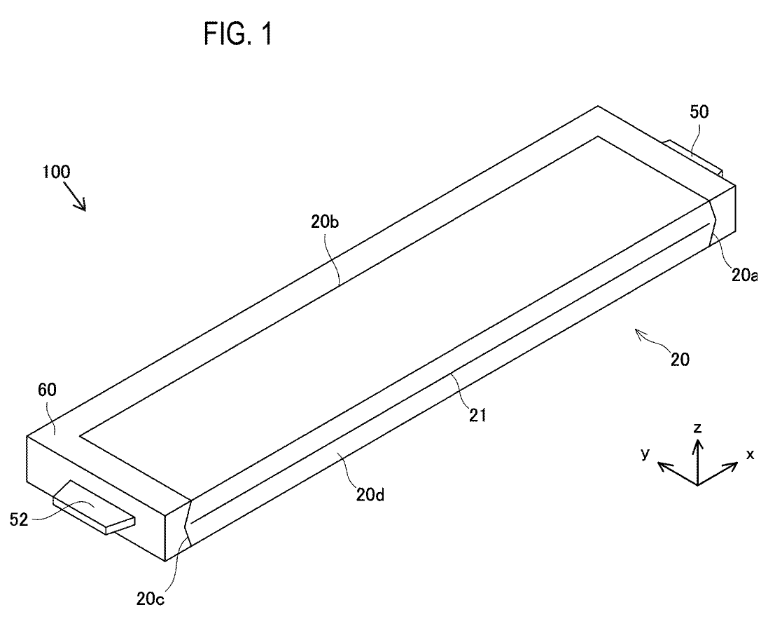

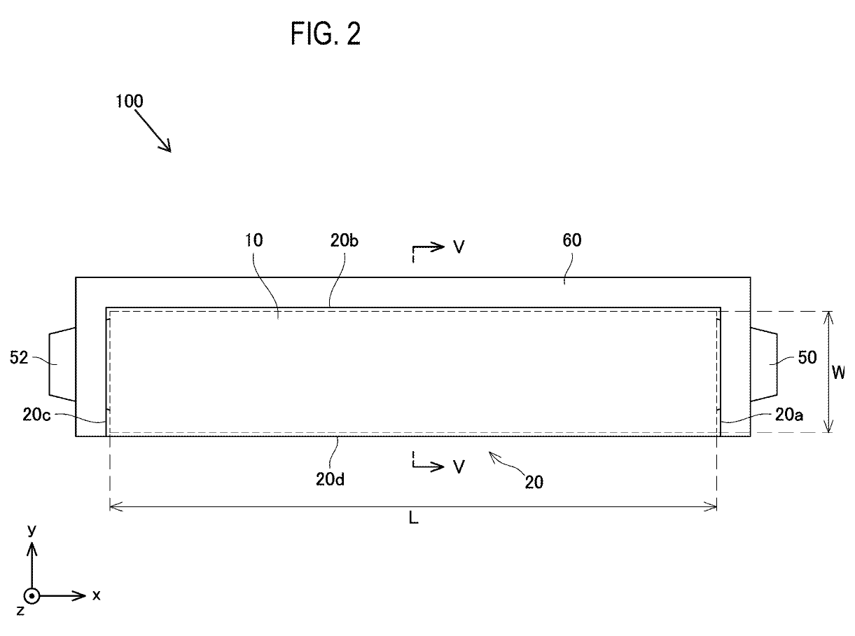

The battery cell 100 shown in FIG. 1 is mounted in, for example, an electrified vehicle. The battery cell 100 has a substantially rectangular plate shape. In the following, a thickness direction of the battery cell 100 is referred to as a z direction, a longitudinal direction of the battery cell 100 is referred to as an x direction, and a width direction of the battery cell 100 (that is, a direction orthogonal to the z direction and the x direction) is referred to as a y direction. In a case of using the battery cell 100, a plurality of battery cells 100 are laminated in the z direction to constitute a battery module. As shown in FIG. 1, the battery cell 100 includes an accommodation member 20. As shown in FIG. 2, a battery main body 10 is housed in the accommodation member 20. The accommodation member 20 houses the battery main body 10 and an electrolytic solution. In addition, an electrode plate 50 is provided at one end part of the battery cell 100 in the x direction, and an electrode plate 52 is provided at the other end part of the battery cell 100 in the x direction. The electrode plate 50 is a positive electrode, and the electrode plate 52 is a negative electrode. In addition, the battery cell 100 includes a resin member 60 that covers a side surface of the accommodation member 20.

The battery main body 10 is a battery that can be repeatedly charged and discharged. As shown in FIG. 2, the battery main body 10 has a substantially plate shape. A ratio (more specifically, a value obtained by dividing the length L by the width W) of the length L to the width W of the battery main body 10 is referred to as an aspect ratio. In the present embodiment, the aspect ratio of the battery main body 10 is 5 or more. The aspect ratio of the battery main body 10 may be 10 or more. Since the aspect ratio of the battery main body 10 is high, the accommodation member 20 has side surfaces 20a, 20c that extend in the short direction and side surfaces 20b, 20d that extend in the long direction. The battery main body 10 is a laminate in which a positive electrode collector foil and a negative electrode collector foil are alternately disposed in the z direction via a separator. Although not shown, a positive electrode collector foil bundle portion in which the positive electrode collector foil is bundled is provided at one end part of the battery main body 10 in the x direction. The electrode plate 50 is connected to the positive electrode collector foil bundle portion. In addition, although not shown, a negative electrode collector foil bundle portion in which the negative electrode collector foil is bundled is provided at the other end part of the battery main body 10 in the x direction. The electrode plate 52 is connected to the negative electrode collector foil bundle portion. The battery main body 10 is immersed in the electrolytic solution filled in the accommodation member 20.

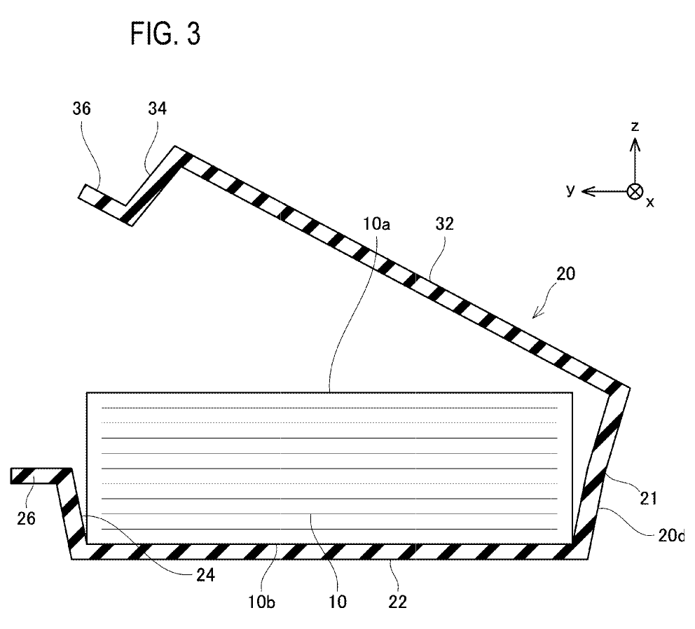

FIG. 3 is a cross-sectional view of the battery cell 100 before the accommodation member 20 is sealed. As shown in FIG. 3, the accommodation member 20 is composed of a film. As the film constituting the accommodation member 20, for example, a laminate film in which a resin coating layer is provided on both surfaces of an aluminum film can be used. The film constituting the accommodation member 20 is molded into a container shape having a first film section 22 and a second film section 32 by an embossing process. A folding line 21 is provided on the side surface 20d of the accommodation member 20. The second film section 32 can swing with respect to the first film section 22 around the folding line 21.

The first film section 22 has a housing portion 24 and a frame portion 26. The housing portion 24 has a cup shape having a recessed portion in which the battery main body 10 can be housed. The frame portion 26 is provided around the housing portion 24 and extends toward a side opposite to the housing portion 24. The second film section 32 has a housing portion 34 and a frame portion 36. The housing portion 34 has a cup shape having a recessed portion in which the battery main body 10 can be housed. The frame portion 36 is provided around the housing portion 34 and extends toward a side opposite to the housing portion 34. In a case where the accommodation member 20 is closed, the upper surface 10a of the battery main body 10 is covered by the housing portion 34. In addition, in a case where the accommodation member 20 is closed, the frame portion 36 overlaps the frame portion 26. In a portion where the frame portion 36 and the frame portion 26 overlap each other, a lower surface of the frame portion 36 (that is, a surface that is on the inside of the accommodation member 20) and an upper surface of the frame portion 26 (that is, a surface that is on the inside of the accommodation member 20) are welded. Hereinafter, a portion where the frame portion 36 and the frame portion 26 overlap each other is referred to as a welding portion 40. In the welding portion 40, the accommodation member 20 is sealed. A width of the welding portion 40 is, for example, 1 mm.

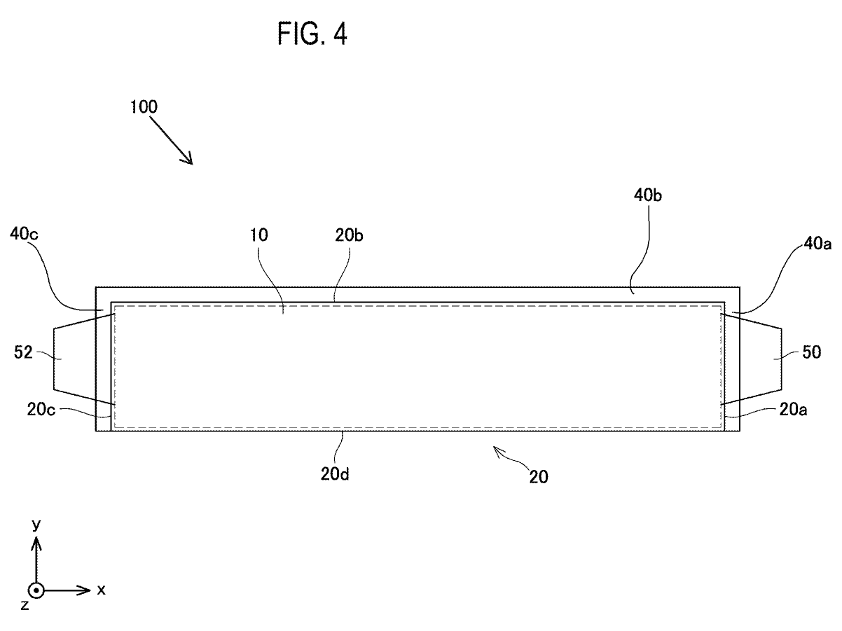

FIG. 4 is a top view of the battery cell 100 after the accommodation member 20 is sealed and before the resin member 60 is provided. As shown in FIG. 4, the welding portion 40 is provided on the side surfaces 20a to 20c of the accommodation member 20 excluding the side surface 20d. That is, the welding portion 40 is provided on the side surfaces 20a, 20b, 20c and is not provided on the side surface 20d. The welding portion 40 protrudes from the side surfaces 20a, 20b, 20c. Hereinafter, a portion of the welding portion 40 provided on the side surface 20a is referred to as a welding portion 40a, a portion of the welding portion 40 provided on the side surface 20b is referred to as a welding portion 40b, and a portion of the welding portion 40 provided on the side surface 20c is referred to as a welding portion 40c.

As shown in FIGS. 1 and 2, the electrode plates 50, 52 extend from the battery main body 10 to the outside of the accommodation member 20. The electrode plate 50 extends from the inside to the outside of the accommodation member 20 through between the frame portion 26 and the frame portion 36 in the welding portion 40a. The electrode plate 52 extends from the inside to the outside of the accommodation member 20 through between the frame portion 26 and the frame portion 36 in the welding portion 40c. In a region of the welding portion 40 where the electrode plates 50, 52 are not present, the frame portion 36 is welded to the frame portion 26. In a region of the welding portion 40a where the electrode plate 50 is present, the frame portion 26 is welded to a lower surface of the electrode plate 50, and the frame portion 36 is welded to an upper surface of the electrode plate 50. In a region of the welding portion 40c where the electrode plate 52 is present, the frame portion 26 is welded to a lower surface of the electrode plate 52, and the frame portion 36 is welded to an upper surface of the electrode plate 52.

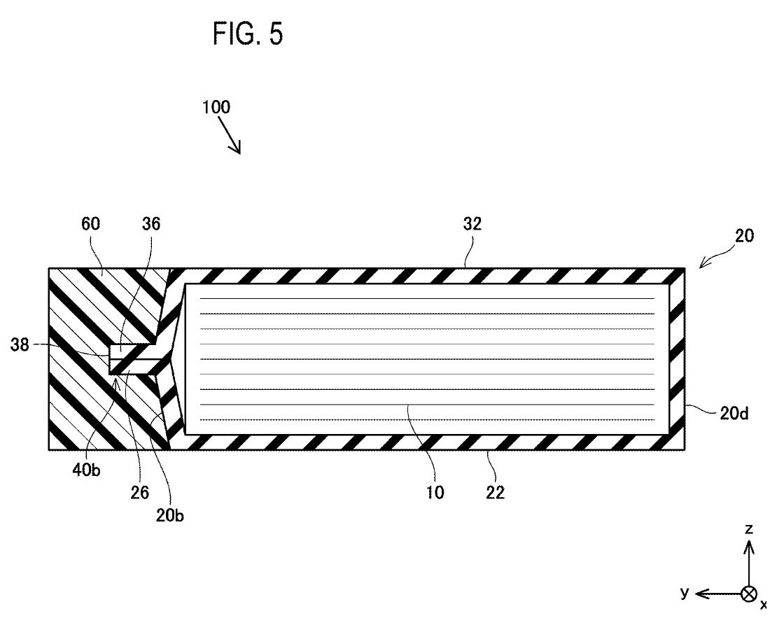

As shown in FIGS. 1 and 2, the battery cell 100 includes the resin member 60. The resin member 60 covers the welding portion 40. More specifically, the resin member 60 covers the entirety of the welding portions 40a, 40b, 40c. Therefore, as shown in FIG. 5, the resin member 60 covers the entirety of the outer peripheral end part 38 of the interface between the frame portion 26 and the frame portion 36. In addition, the resin member 60 covers the side surfaces 20a to 20c. The resin member 60 is formed by injection molding and is fixed to the accommodation member 20 in close contact with the accommodation member 20. A thickness (that is, a dimension in the z direction) of the resin member 60 is substantially equal to a thickness of the battery main body 10. However, the thickness (that is, the dimension in the z direction) of the resin member 60 may be thinner than the thickness of the battery main body 10.

In the above-described embodiment, the resin member 60 covers the welding portion 40 of the accommodation member 20. Therefore, high sealing capability can be achieved in the welding portion 40. In particular, since the resin member 60 covers the welding portion 40 and the side surfaces 20a to 20c of the accommodation member 20, higher sealing capability can be achieved. Therefore, even in a case where the width of the welding portion 40 is shortened as compared with the related art, high sealing capability can be achieved.

In addition, in the above-described embodiment, since the resin member 60 is provided around the accommodation member 20, rigidity of the battery cell 100 is high.

In the above-described embodiment, the resin member 60 extends in an xy plane. Therefore, in a case of using the battery cell 100, it is easy to laminate a plurality of battery cells 100, so that assemblability of the battery cell 100 is improved.

### Embodiment 2

The battery cell 102 of Embodiment 2 is different from Embodiment 1 in that the battery cell 102 includes a heat conduction member 62. The other configurations of Embodiment 2 are the same as those of Embodiment 1.

The heat conduction member 62 covers a surface of the resin member 60. The heat conduction member 62 may cover the entirety of the surface of the resin member 60 or may cover a part of the surface of the resin member 60. The heat conduction member 62 has a higher thermal conductivity than the resin member 60. The heat conduction member 62 is, for example, an aluminum sheet.

In a case of charging and discharging the battery cell, heat is generated in the battery main body. The battery cell 102 of Embodiment 2 includes the heat conduction member 62 that covers the surface of the resin member 60. The heat conduction member 62 has a higher thermal conductivity than the resin member 60. Therefore, the heat generated in the battery main body 10 is efficiently released to the outside via the heat conduction member 62. Therefore, an increase in temperature of the battery cell 102 can be suppressed.

### Embodiment 3

The battery cell 103 of Embodiment 3 is different from Embodiment 1 in that the battery cell 103 includes a sealing material 64. The other configurations of Embodiment 3 are the same as those of Embodiment 1.

The sealing material 64 is provided between the resin member 60 and the welding portion 40. The sealing material 64 covers the outer peripheral end part 38 of the interface between the frame portion 26 of the first film section 22 and the frame portion 36 of the second film section 32. Therefore, it is difficult for a liquid to pass through the interface between the frame portion 26 and the frame portion 36, and it is possible to prevent the liquid from entering the inside of the battery cell 100 from the outside of the battery cell 100.

In Embodiments 1 to 3, unevenness portions may be provided on the upper surface and the lower surface of the resin member 60. According to this configuration, in a case of laminating a plurality of battery cells, the unevenness portions function as positioning members for the adjacent battery cells. Therefore, assemblability of the battery cell is improved.

The resin member 60 covered the side surfaces 20a to 20c. However, the resin member 60 need only cover at least one of the side surfaces 20a to 20c. For example, the resin member 60 may be provided at the welding portion 40b and the side surface 20b and may not be provided at the welding portions 40a, 40c and the side surfaces 20a, 20c.

The lower surface 10b is an example of the "first surface". The upper surface 10a is an example of the "second surface".

Although the embodiments have been described in detail above, the above is merely an example and does not limit the scope of claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A battery cell comprising:
a battery main body;
an accommodation member that accommodates the battery main body; and
a resin member, wherein:
the accommodation member includes
a first film section that covers a first surface of the battery main body, and
a second film section that covers a second surface on a side opposite to the first surface;
a welding portion in which an inner surface of the first film section and an inner surface of the second film section are welded is provided on a side surface of the accommodation member, the welding portion protruding from the side surface; and
the resin member covers the side surface of the accommodation member and the welding portion.

2. The battery cell according to claim 1, wherein:
the side surface of the accommodation member includes a first side surface and a second side surface extending in a direction intersecting the first side surface when the side surface is viewed in a plan view along a thickness direction of the battery cell;
the welding portion includes a first welding portion provided on the first side surface and a second welding portion provided on the second side surface; and
the resin member covers the first side surface, the first welding portion, the second side surface, and the second welding portion.

3. The battery cell according to claim 1, wherein a length of the battery main body is at least 5 times a width of the battery main body.

4. The battery cell according to claim 1, further comprising a heat conduction member that covers a surface of the resin member, the heat conduction member having a thermal conductivity higher than a thermal conductivity of the resin member.

5. The battery cell according to claim 1, further comprising a sealing material provided between the resin member and the welding portion.
